(19) United States
(12) Patent Application Publication
(10) Pub. No.: US 2009/0063810 A1
(43) Pub. Date: Mar. 5, 2009

(54) Computing Device with Automated Page Based RAM Shadowing, and Method of Operation

(75) Inventor: Charles Garcia-Tobin, Cambs (GB)

Correspondence Address: Saul Ewing LLP (Philadelphia), Attn: Patent Docket Clerk, 2 North Second St., Harrisburg, PA, 17101, US

(73) Assignee: Symbian Software Limited, London (GB)

(21) Appl. No.: 11/908,674

(22) PCT Filed: Mar. 15, 2006
(86) PCT No.: PCT/GB2006/000930

§ 371 Date: Apr. 22, 2008

(30) Foreign Application Priority Data
Mar. 15, 2005 (GB) 0505289.9

(51) Int. Cl. G06F 12/06; G06F 15/177

(52) U.S. Cl. 711/209; 713/2; 711/E12.078

(57) ABSTRACT

Where a computing device is provided with executable programs in relatively slow non-volatile memory, such as ROM, the device performance can be improved by shadowing, a process by which those programs are copied into relatively fast volatile memory, such as RAM. Shadowing is often inefficient because code is copied that is too infrequently used to benefit from the procedure, wasting processing time and memory. The present invention determines which parts of the slow memory are most frequently accessed, either by profiling or by intimate knowledge of the working of the device, and then shadows only those pages of executable programs whose frequent use warrants it. In a preferred embodiment the most frequently used code areas are clustered together onto certain pages of the non-volatile memory and the least frequently used code areas are clustered onto other pages of non-volatile memory.

This invention relates to computing devices, and in particular to an improved method of improving the performance of computing devices which execute code stored in relatively slow memory.

The term computing device as used herein is to be expansively construed to cover any form of electrical computing device and includes, data recording devices, computers of any type or form, including hand held and personal computers such as Personal Digital Assistants (PDAs), and communication devices of any form factor, including mobile phones, smart phones, communicators which combine communications, image recording and/or playback, and computing functionality within a single device, and other forms of wireless and wired information devices, including digital cameras, MP3 and other music players, and digital radios.

Modern computing devices include multiple types of memory. Some of these types of memory, such as conventional static and dynamic RAM (Random Access Memory), are fast but volatile; the contents of RAM are only retained within that memory when the device is powered up. Other types of memory, such as ROM (Read Only Memory) and Flash are significantly slower than RAM but are non-volatile; the contents of these types of memory can be used for permanent storage because the contents is retained even when the device is off.

It is widely recognised that there is a requirement for computing devices to be provided with programs that are essential to the proper functioning of the device in some type of permanent non-volatile storage as part of the manufacturing process. Such programs may be part of the boot-up procedures which run when the device is powered up, or they may provide operating system services that are required frequently, or they may be critical applications. Therefore they need to be provided in non-volatile memory, such as ROM or Flash memory.

However, it is also widely recognised that such non-volatile memory is significantly slower in operation than RAM, and this means that executing programs from non-volatile memory does not allow a device to operate at optimal speed. Because users place a very high value on the speed with which their computing devices operate, manufacturers have developed a technique known as shadowing which seeks to alleviate this difficulty. Shadowing denotes the copying of executable code from one type of memory to another in order to improve the performance of the device. It is most frequently used in the context of copying system software from relatively slow XIP (eXecute In Place) ROM to relatively fast RAM.

This method first came to prominence in mass-market computing devices in the mid 1980s, when the first CPUs to implement virtual memory addressing became widely available. These were often used in devices which provided a commonly used BIOS (Basic Input-Output System) code in ROM memory. The ability of such CPUs to map virtual memory addresses to different physical memory locations meant that it was possible to copy the entire contents of the relatively slow ROM BIOS into much faster RAM, and then to remap the virtual addresses of the BIOS code to point at the copy in RAM.

Those skilled in this art will be aware that the total of all the addressable memory locations in use are termed virtual memory and that modern computing devices contain a mapping of virtual memory pages to physical memory pages, held in page tables that are maintained by a memory management unit or MMU. By altering the contents of these page tables, a set of virtual memory addresses can be made to point at any desired area of addressable physical memory.

Although the process of copying the contents of the ROM BIOS into RAM took some time, and the method arguably wasted valuable memory (since executable code is being duplicated) this process of shadowing executable code from relatively slow memory to faster memory did improve the overall performance of computing devices, because the BIOS code was executed so frequently during normal operation of the device: in essence the device was no longer being slowed down by the necessity to access a ROM for each of the BIOS routines.

Shadowing executables to improve performance is specifically a feature of operating systems for battery operated mobile computing devices, such as cellular telephones. There are a number of approaches to shadowing that can be used in such devices. Two of these are referred to in Micron Technology's paper entitled “Comparing XIP and Code Shadowing Architectures for 2.5 G Cellular Phones”:

“Code shadowing can be achieved in one of two ways:
Copy all the code area at boot-up . . . an overhead of 100 percent of the code space is reserved in the RAM space to execute applications.
Copy-on-demand the application for execution . . . this reduces the overhead of RAM space by almost two times (50 percent of the code needs to be reserved in the RAM space), but it also increases the complexity and latency of dynamic downloading.” (from http://www.micron.com/publications/wireless3q034q03.html)

A practical example of the first type of shadowing can be seen in certain implementations of the Windows CE™ operating system from Microsoft™ in which:

“The entire image is stored in flash . . . and copied from flash into RAM during system initialization, then it runs from RAM.” (see http://www.intel.com/design/flcomp/applnots/29223701.pdf).

A variant of the second type of shadowing referred to above can be found in certain implementations of the Symbian OS™ operating system, the advanced operating system for mobile phones from Symbian Software Limited. This operating system speeds up the operation of devices by copying only frequently accessed executable files from relatively slow memory to RAM, from where the files execute at a higher speed. This copying process is carried out at device boot time rather than on demand during device operation.

Although the different approaches described above (shadowing either entire operating system images or entire executable files) are known to improve overall system performance, they are also widely recognised to have certain disadvantages:
They are not memory efficient. Typically, only a small percentage of the code copied is used frequently enough to warrant shadowing, but the whole image (for Windows CE) or executable files (for Symbian OS) is/are copied, and this takes up valuable RAM.
They are not time efficient—this follows from the previous disadvantage: copying code that is not used frequently enough to warrant shadowing can slow down the system.

Time inefficiency is a particular concern during the boot process when the device is first switched on. Optimisations here are considered especially important for mobile battery operated devices, such as smart phones, because users expect these to become fully operational upon power-up with minimal delay. For example, in the case of a cellular phone, a long period between actually switching the device on and being able to make a call is widely recognised to be very frustrating to the user and may, for example in emergency situations, give rise to higher concerns with the user.

However, operating system image shadowing and executable file shadowing are both sub-optimal in this respect and offer clear scope for improving boot-up time:
Shadowing the entire operating system image as part of the boot process is sub-optimal because not all of the code which is actually copied is needed to boot the device.
Executable file shadowing not only wastes time shadowing unused portions of executable files, but also cannot be brought into action until the file system is initialised and ready to use. Consequently it can only be used for a part of the boot process. It is also worth noting that where application code is shadowed on a per-executable basis, this can also slow down application start-up.

So while shadowing is a proven method for improving the performance of computing devices which store executable code in slower types of memory, there has to date been no method disclosed for optimising this particular functionality.

It is therefore an object of the present invention to provide an improved form of RAM shadowing.

According to a first aspect of the present invention there is provided a method of operating a computing device comprising shadowing one or more pages of memory provided in non-volatile memory to relatively faster volatile memory, and mapping the shadowed pages into virtual memory addresses previously associated with the said pages in the non-volatile memory.

According to a second aspect of the present invention there is provided a computing device comprising shadowing means for shadowing one or more pages of memory provided in non-volatile memory to relatively faster volatile memory, and mapping the shadowed pages into virtual memory addresses previously associated with the said pages in the non-volatile memory.

According to a third aspect of the present invention there is provided an operating system for a computing device for causing a computing device according to the second aspect to operate in accordance with a method of the first aspect.

Embodiments of the present invention will now be described, by way of further example only, with reference to the accompanying drawings in which:—

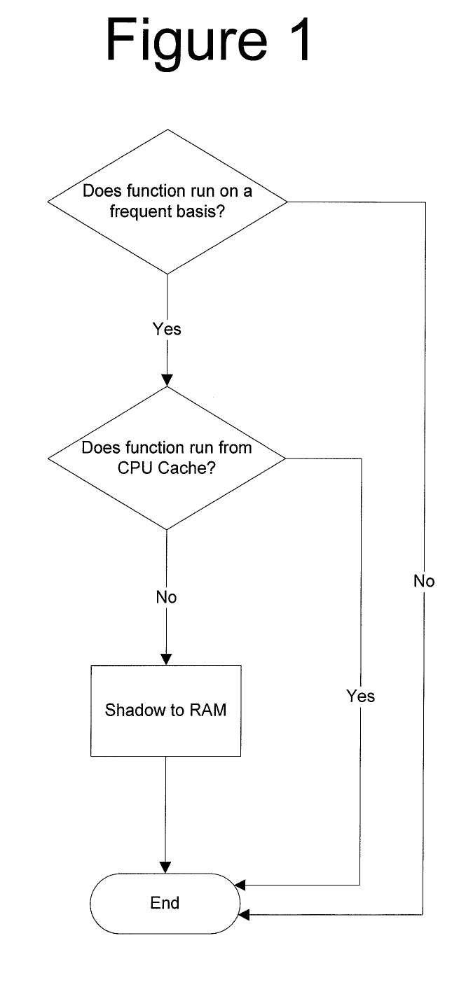

FIG. 1 shows a process for selecting functions to shadow to RAM;

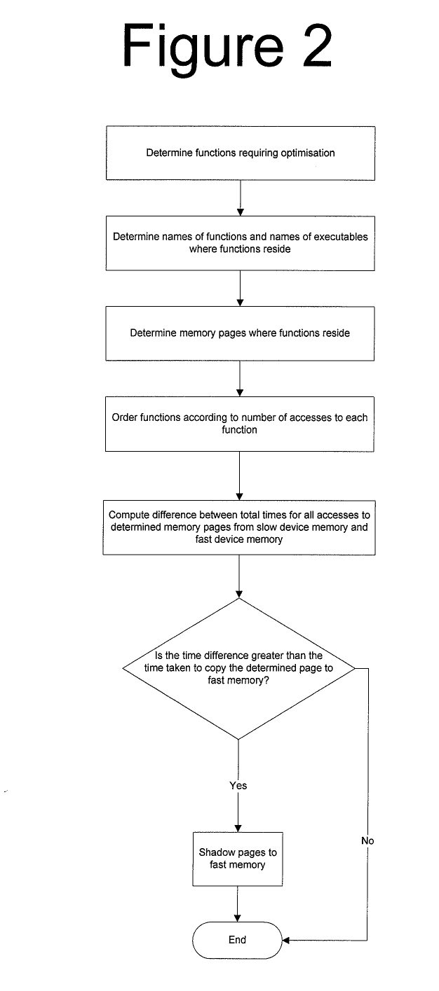

FIG. 2 shows a process for determining which selected functions can beneficially be shadowed to RAM;

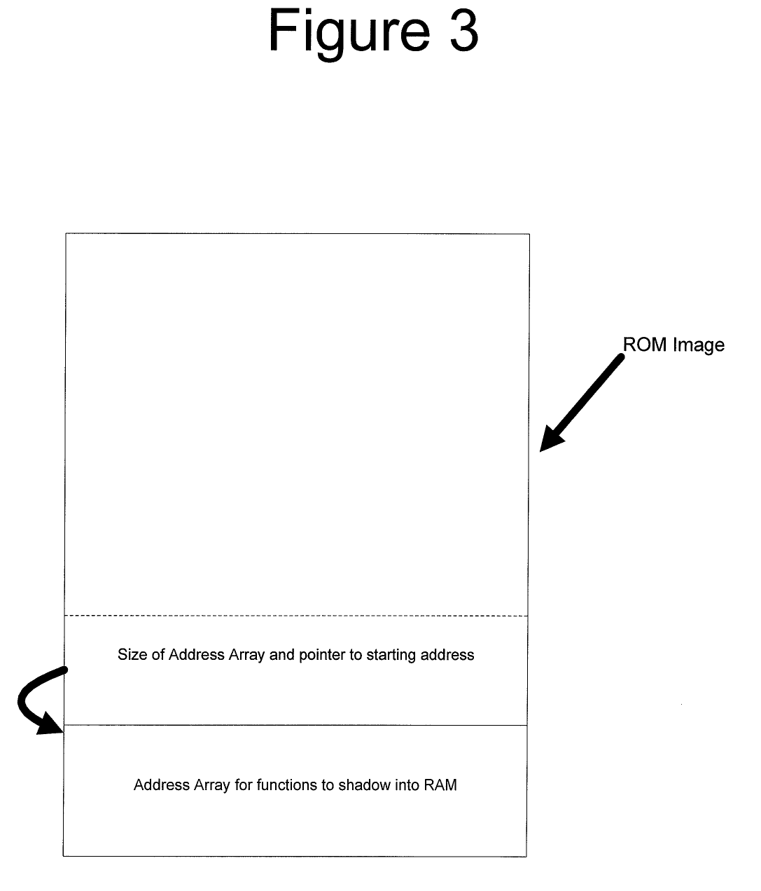

FIG. 3 shows schematically a ROM image for a device embodying the present invention;

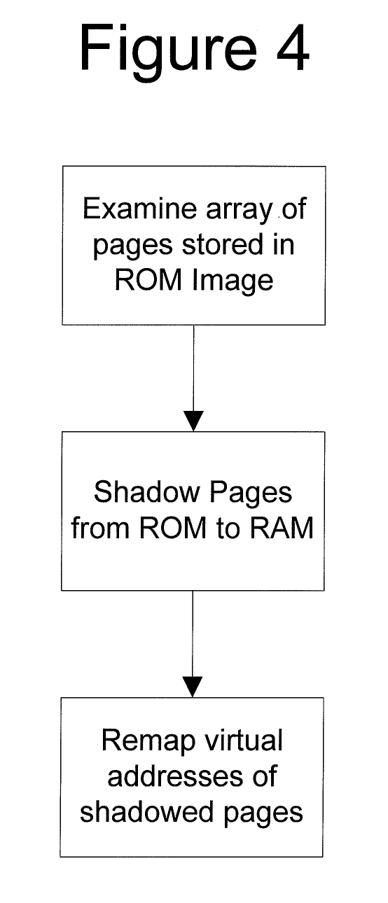

FIG. 4 shows a process for shadowing functions of the ROM image shown in FIG. 3;

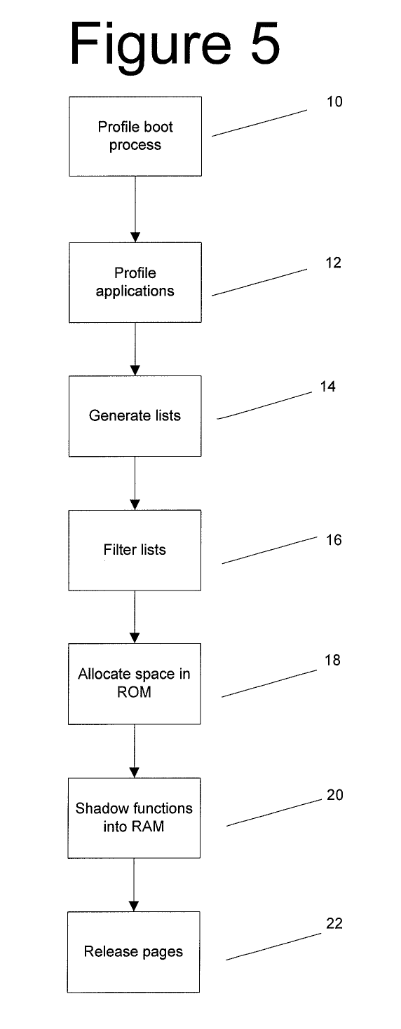

FIG. 5 shows a process for implementing the present invention in a computing device whose operating system is able to shadow executable files on demand, and

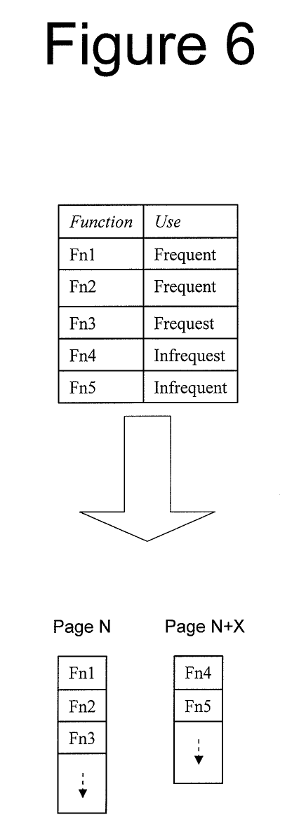

FIG. 6 shows a preferred embodiment of the present invention in which functions which are most frequently loaded from slow memory are arranged to reside in the same pages.

This invention is predicated on the basis that instead of shadowing either a complete operating system image or a complete executable file, executables are instead shadowed by page. This is particularly advantageous because shadowing by page not only removes much of the need to copy code that is not used frequently enough to warrant shadowing, but also optimises both memory usage and the time overhead of shadowing. Furthermore, because this invention does not depend in any way on a filing system, it can be used throughout the boot process.

In one embodiment of the invention, a method of enabling RAM shadowing by page of frequently used code which can be implemented at system start-up is envisaged. The first step in this embodiment is to determine which areas of code require optimising. Approaches which may be used to achieve this may comprise:
a) Manual selection: a skilled person with sufficient knowledge of the system would be likely to know which areas of code would benefit from layout optimisation.
b) Automatic selection: a profiler can be used to find the areas of code that are most frequently accessed from slow memory.

Ideally, a specialised profiler should be used for automatic selection. This is because there is a risk that a conventional profiler would only find those areas of code which are accessed most often, and this is not necessarily the code to be optimised. As an example, where code is accessed from slow memory just once during the execution of a program, and is then repetitively run on a relatively frequent basis, it is by no means impossible that the subsequent attempts to access this code will find it in the CPU cache. Consequently, there would be no need for subsequent access from slow memory because it can be run from the CPU cache. Hence, shadowing such code would be sub-optimal. This process is shown in FIG. 1. The type of profiler used should, therefore, only take account of code accesses which are made directly from the slow memory: in essence this is equivalent to that subset of accesses which are accompanied by a cache miss.

The output of this first step, whether performed by manual selection or automatically through the use of a profiler, is in the form of a list of functions or procedures (hereinafter referred to simply as functions). For each one, the name of the executable or library where it resides in addition to the name of the function itself is determined, as shown in FIG. 2. This raw list of functions can then be processed so that it is ordered according to the number of accesses to each function.

Preferably, function names rather than actual addresses are used in this embodiment because whenever a new binary image is built for a system, the address of a given function is relatively likely to change because the size of the code around it will have changed. Inversely, it is rare for the function name, and the name of the executable or library where it resides, to be modified.

As shown in FIG. 2, the next step is to determine, for a given build of the system and taking as input the ordered list of functions obtained in the first step above, the pages where the most commonly accessed functions reside.

Both the size of each function and the size of the memory page in the device are known. Therefore the list of functions can be arranged in a series of possible pages, and these can be ordered from the most frequently accessed to the least frequently accessed.

Those skilled in the art will realise that for each possible page, it is now possible for any page, with sufficient knowledge of both the code in each page and the hardware specifications of the computing device in question, such as the various types of memory available, including clock frequencies, access times, wait states and data transfer speeds, both for reading and writing, the specifications of any CPU on the device, including clock frequencies and cache specifications, to compute the difference between the total time for all accesses to the page from fast memory and the total time taken for all accesses to the page from slow memory; this is a deterministic mathematical operation. If this time difference is greater than the time it would take to copy the page from slow memory to fast memory, then it is known that shadowing such pages will improve the performance of the system.

Should available RAM in the device be scarce, and should it not be possible to shadow all those pages which are determined as above to offer a performance benefit, the system architect will nevertheless have the information needed to set a figure for an appropriate number of shadowed pages, possibly selecting those pages ranked to provide the greatest performance benefits. Bearing in mind that this optimisation will be carried out during the design process for the device, it may alternatively be decided to increase the amount of RAM in the system should the performance benefit warrant this. Those skilled in the art will be aware that the typical build process of an executable ROM image for an embedded system includes all the necessary tools required to obtain symbolic information concerning that image. This in turn provides the address of every function in the image. From these addresses and knowledge of the memory settings of the operating system being used, it is possible to obtain the addresses of the pages. Furthermore, for those skilled in the art, it is not an overly complex operation to write a tool that will determine addresses automatically whenever a new image is built. In this way the process of determining which pages to shadow can be fully automated.

Once the details of the pages that are to be shadowed, together with the size of the ROM itself are known, it is possible to allocate some of the unused space at the end of the code in the ROM image of sufficient size to hold an array of addresses of pages to be shadowed, as shown in FIG. 3. It is pointed out that the ROMs in almost all computing devices have some unused space so it would be most unusual for a ROM to be so completely full that there would be insufficient room for a small page array of this type. Again, if there is insufficient space in the ROM image to hold this array of addresses, then the size of the ROM image may also be increased if the performance benefits warrant this.

Finally, the constructed ROM image, its symbolic information, and the list of frequent functions are input to a utility program. The symbolic information and the list of frequent functions are used by the utility program to construct an array of pages to be shadowed as outlined above, and this information is inserted into the pre-allocated area of the ROM image. To write such a program is not considered overly complex for a person skilled in this art. Both the size of this array and a pointer to its starting address are stored at a predetermined location in the ROM. Typically, this can be in the data area used by the bootstrap code. This is an overhead of only a few bytes of code and does not, therefore, give rise to any performance concerns.

In use of the device, this array of pages stored in the ROM image is examined during the early stages of the boot process whenever the device is powered up. When valid page addresses are found, the boot process calls the relevant shadow API to copy these pages from ROM to RAM and then causes the memory manager to remap their virtual addresses. This procedure is shown in FIG. 4. Once this has been done, access to the relevant code will always take place from the relatively fast RAM rather than from the relatively slow ROM. Hence, the device is provided with the benefits of shadowing in an optimised way and without the performance penalties as outlined above.

Each time a new ROM image is built, the size of the image and the location of functions in pages is likely to change. Therefore the steps of determining the pages where the most commonly accessed functions reside, including the size and function of the pages, the allocation of some of the unused space at the end of the code in the ROM image of sufficient size to hold an array of addresses of pages to be shadowed, and the insertion of the array of addresses into the pre-allocated area of the ROM image can be repeated in order to generate a revised image that can once again be optimally shadowed.

However, the first step described above only needs to be repeated when there is a large change in the design or architecture of the computing device which is likely to cause a change in the list of frequently accessed functions.

According to a second embodiment of the invention, the above method can be modified so that it can be used for a computing device whose operating system shadows executable files on demand, as disclosed in the Micron paper referred to above. This type of shadowing could reasonably be used either independently or in addition to shadowing of code required for use during the boot process in connection with any executables and applications which are not required to be loaded until later. It is the latter variation which will be described next with reference to FIG. 5.

In this embodiment of the invention, the initial stage of the process described above is, in essence, split into two parts. Profiling the boot process reveals which code needs to be shadowed to optimise the performance on start-up; profiling applications subsequently loaded reveals which portions of their code need to be shadowed. The output of this initial stage is therefore a first list of functions and procedures for optimising the boot process, in combination with a second list of functions and procedures for each application which are to be shadowed. This is shown as steps 10 to 14 in FIG. 5.

The next stage of this embodiment proceeds as described above for the lists generated by the first step of the first embodiment. However, in this second embodiment, the lists for the applications are filtered at step 16 of FIG. 5 to ensure that they do not duplicate any entries from the list of pages to be shadowed at start-up.

In this embodiment it is necessary to allocate space in the ROM not just for the address array of pages to be used on start-up, but also for a separate array for each application which is also to be shadowed. This is shown as step 18 in FIG. 5. These latter arrays can be identified separately by application name: storing an index with starting addresses and lengths immediately after the array used to optimise start-up is one of a number of possible methods that can be used for this purpose. However, depending on its design, the utility program used to construct the arrays of pages to be shadowed may need to be modified to cope with generating multiple tables for the ROM.

As in the first embodiment, the array of pages generated for use in the boot process is examined and acted upon whenever the device is powered up. However, in this embodiment the application loader in the device is also modified so that it checks, for each application, whether a page array has been constructed for it. The time taken for this check to be conducted is negligible, in relative terms. If an array is found to exist for any application, and if that array contains valid page addresses, the loader calls the relevant shadow API to copy these pages from ROM to RAM and causes the memory manager to remap their virtual addresses, shown as step 20 in FIG. 5. As with the pages shadowed during boot, this will ensure that access to the relevant code will always take place from RAM rather than ROM; once again, the system is provided with the benefits of shadowing without the performance penalties of the known art.

A possible optimisation of this embodiment of the invention is for the termination of a partially shadowed application to be accompanied by a release of the pages of memory that were mapped when it was loaded, as shown by step 22 in FIG. 5.

Further optimisations of all aspects of the invention are also possible. For example, the strict determination of those functions and procedures which warrant being shadowed by reference to their ordering on the list of those most frequently accessed from slower memory might be relaxed to take account of best-fit constraints as applied to memory pages, so that functions that are too large to fit in the remaining space in a page are passed over in favour of those that will.

Referring to FIG. 6, one optimisation of particular interest is to arrange the layout of code so that those areas which are most frequently loaded from slow memory, and would consequently gain the most benefit from being shadowed, reside in the same pages. It is pointed out specifically that this optimisation is not the same as known code optimisations which are based on the phenomenon of locality, the study of which stretches back over three decades. Locality may be defined as

“the phenomenon that memory references tend to be clustered in small memory areas during the execution of a program” (from “Ordering functions for improving memory reference locality in a shared memory multiprocessor system” by Youfeng Wu in Proceedings of the 25th annual international symposium on Microarchitecture table of contents, 1992).

The paper by Youfeng Wu quoted above discloses methods of building compilers which increase the amount of locality within a program. It is known that increasing locality can lead to a reduction in cache misses and page faults, with a concomitant substantial improvement in performance.

However, optimising the layout of functions so that those which are sequentially accessed are adjacent or contiguous to each other in memory is a very different type of operation to optimising the layout of functions so that those which are most frequently accessed from slow memory are adjacent to each other. The former optimisation depends on a spatial measurement whereas, in strict contrast, the latter optimisation depends on a temporal measurement.

These two types of optimisation may have a mutual affect on each other and this is one reason why a different specialised profiling tool might be considered desirable for optimisation of shadowing. However, since caching generally gives greater performance benefits than shadowing, spatial optimisation for better cache performance should take precedence over temporal optimisation for more efficient shadowing. An iterative process of either mathematical simulation or testing may, therefore, accompany each cycle of optimisation to ensure that performance has increased and has not inadvertently become degraded.

Those skilled in the art will appreciate that laying out code so that those areas which are most frequently loaded from slow memory reside in the same pages is of benefit not just to systems which implement code shadowing, but would most certainly also be of benefit to any system that implements page-based memory management.

It will be noted from this description that it may be considered advantageous for a computing device incorporating this invention to be manufactured with the aid of specialised software engineering tools, such as profilers, ROM analysers and performance simulators. It is to be understood that in such circumstances, both the computing device and any such engineering tools used to produce the device are to be considered as falling within the scope of this invention.

The present invention provides several advantages over the known methods of shadowing, including:—
a memory efficient method for shadowing all types of executables in XIP ROM based systems. Practical experiments using the Symbian OS™ operating system have shown that shadowing by page rather than file reduces RAM requirements by approximately a factor of 10, with no significant decrease in performance of the device
when compared to file-based paging methods, optimisation does not require the presence of a file system and can therefore be initiated earlier in the boot process, resulting in faster device boot times
page-based shadowing is faster than file-based shadowing because it does not need to call any file system code
when compared to operating system image based paging methods, there is no need to copy pages which do not warrant shadowing; consequently the RAM overhead is smaller and it is also much faster
clustering code that is frequently accessed from slow memory into a common set of pages can also benefit any system that implements page based memory management.

Although the present invention has been described with reference to particular embodiments, it will be appreciated that modifications may be effected whilst remaining within the scope of the present invention as defined by the appended claims.

1. A method of operating a computing device comprising shadowing one or more pages of memory provided in non-volatile memory to relatively faster volatile memory, and mapping the shadowed pages into virtual memory addresses previously associated with the said pages in the non-volatile memory.

2. A method according to claim 1 wherein the pages to be shadowed are determined from a list comprising the names of those functions and procedures ordered on the basis of a frequency of access of the pages of memory from the non-volatile memory.

3. A method according to claim 1 wherein details of the pages to be shadowed are stored in non-volatile memory of the device at a fixed location.

4. A method according to claim 1 wherein details of the pages to be shadowed are stored in non-volatile memory of the device in a variable location together with a pointer to the location of the said details which is stored in a fixed location.

5. A method according to claim 2 wherein the list is constructed with reference to any one or more of:
a. a boot process initiated on power-up of the device;
b. one or more executables; or
c. a typical usage pattern of an average user of the device.

6. A method according to claim 5 wherein the pages associated with each executable are stored in a linked list or are referenced by an index.

7. A method according to claim 5, as applied to one or more executables, wherein a system loader for the executables retrieves the details of any pages to be shadowed for each executable and arranges for the shadowing of the said pages so specified.

8. A method according to claim 5, as applied either to the boot process initiated on power-up or to the typical usage pattern of an average user, wherein the boot process includes means for retrieving the details of the pages to be shadowed and the shadowing of the said pages so specified.

9. A method according to claim 5 wherein, when the list is constructed from a combination of more than one of options a, b, or c, the list is arranged to comprise functions which are mutually exclusive.

10. A method according to claim 5, wherein those pages shadowed from an executable are freed when the said executable terminates.

11. A method according to claim 2 wherein the list is determined by a manual process based on a knowledge of the architecture and design of the computing device.

12. A method according to 2 wherein the list is determined by a profiler for identifying those pages most frequently accessed from non-volatile memory.

13. A method according to claim 2 wherein the list is compiled with reference to any one or more of the following factors:
a. the size of the memory page used on the device;
b. the size of the functions and procedures of the list;
c. the number of CPU cycles typically required by the said functions and procedures;
d. the frequency with which the said functions and procedures are referenced;
e. the specifications of the various types of memory available on the said device, including but not limited to memory space, clock frequencies, access times, wait states and data transfer speeds, both for reading and writing;
f. the specifications of any CPU on the device, including clock frequencies and cache specifications;
g. the remaining space in any page;
h. symbolic information obtained from previous builds of the contents of non-volatile memory for the device.

14. A method according to claim 13 wherein the list is constructed with reference to the said factors by means of an automated tool.

15. A method according to claim 2 wherein functions determined to be most frequently accessed from the non-volatile memory are grouped together in pages.

16. A method according to claim 2 wherein it is determined whether shadowing of any of the one or pages in volatile memory provides any performance benefit for the device in comparison to maintaining the said any of the one or more pages at contiguous locations in non-volatile memory, and if it is determined that there is no performance benefit, or that the performance of the device is degraded, then the said any of the one or more pages are not shadowed into volatile memory.

17. A method according to claim 13 wherein the size of the memory available on the device is increased if the pages to be shadowed cannot be accommodated in the available memory.

18. A computing device comprising shadowing means for shadowing one or more pages of memory provided in non-volatile memory to relatively faster volatile memory, and mapping the shadowed pages into virtual memory addresses previously associated with the said pages in the non-volatile memory.

19. A device according to claim 18 wherein the shadowing means is arranged to compile a list comprising the names of those functions and procedures ordered on the basis of a frequency of access of the pages of memory from the non-volatile memory.

20. A device according to claim 18 wherein details of the pages to be shadowed are stored in non-volatile memory of the device at a fixed location.

21. A device according to claim 18 arranged to store details of the pages to be shadowed in non-volatile memory of the device in a variable location together with a pointer to the location of the said details which is stored in a fixed location.

22. A device according to claim 18 arranged to construct the list with reference to any one or more of:
a. a boot process initiated on power-up of the device;
b. one or more executables; or
c. a typical usage pattern of an average user of the device.

23. A device according to claim 22 wherein the pages associated with each executable are arranged to be stored in a linked list or are to be referenced by an index.

24. A device according to claim 22, as applied to one or more executables, wherein a system loader for the executables is arranged to retrieve the details of any pages to be shadowed for each executable and to arrange for the shadowing of the said pages so specified.

25-32. (canceled)

33. An operating system for causing a computing device according to claim 18 to operate in accordance with a method as claimed in claim 1.
